(19) United States
(12) Patent Application Publication
(10) Pub. No.: US 2007/0134402 A1
(43) Pub. Date: Jun. 14, 2007

(54) DRY FLAVORING BLEND AND METHOD OF MAKING SAME

(76) Inventor: DAVID P. FEDER, Buffalo Grove, IL (US)

Correspondence Address: MCKEE, VOORHEES & SEASE, P.L.C., 801 GRAND AVENUE, SUITE 3200, DES MOINES, IA, 50309-2721, US

(21) Appl. No.: 11/549,694

(22) Filed: Oct. 16, 2006

Related U.S. Application Data
(60) Provisional application No. 60/727,363, filed on Oct. 17, 2005.

(51) Int. Cl. A23L 1/221

(52) U.S. Cl. 426/650

(57) ABSTRACT

A dry or semi-dry flavoring blend comprising main ingredient of ground dried olives or olive pulp is described. The ground dried olives or olive pulp are mixed with one or more other flavorings, seasonings, condiments, herbs, extracts, or spices to achieve a dry flavoring blend useful as a seasoning, rub, condiment, or in marinades, as well as other culinary uses.

### PRIORITY STATEMENT

This application claims priority to U.S. Provisional Patent Application No. 60/727,363, filed Oct. 17, 2005, herein incorporated by reference in its entirety.

### BACKGROUND OF THE INVENTION

A. Field of the Invention

Olives are a significant food item throughout most of the world. Authorities indicate the history of olives to be as follows. Olives have been used in various forms and for various purposes for over 12,000 years. They were first cultivated in the eastern part of the Mediterranean, in the region known as the “fertile crescent”, and moved westward over the millennia. Olive cultivation began in approximately 5000 B.C. and gradually spread throughout the eastern Mediterranean by 1400 B.C. Commercial use and applications then brought olive cultivation to southern Turkey, Cyprus, and Egypt. By approximately 1500 B.C., Greece was the area most heavily cultivated. As the Greek colonies expanded, olive tree culturing spread to southern Italy and northern Africa in the 8th Century B.C., and subsequently spread to southern France. By Roman times, olive trees were planted in the entire Mediterranean basin.

In the Middle East, King Solomon and King David placed great importance on the cultivation of olive trees. King David even had guards watching over the olive groves and warehouses. Olive trees dominated the Greek countryside and became pillars of Hellenic society. In ancient Greece and Rome, olive oil was a primary commodity. Advanced ships were built having the sole purpose of transporting olive oil from Greece to various trading posts around the Mediterranean.

While olives have enjoyed wide and diverse uses throughout their long history, their primary uses have been (a) use of extracted oil from the olive pulp for cooking or flavoring, (b) use, in whole or in part (and with or without pimento), as a food item or as an addition to other foods (cooked or uncooked), or (c) use of their pulp, in paste form, as a condiment.

Thus, the conventional uses of olives have all been focused on the oil within the olive pulp. Either the liquid from the olive, the oil and water, is substantially extracted for further use and the remainder of the olive (the olive solids) discarded, or the olive or its pulp, with its natural oil and hydration content intact, is used. Olives have not been reported to be used as the primary ingredient of a dry flavoring blend.

Information exists that, in ancient times, the wood and/or pit of olives was ground into dry powdered form and used in food items. Also, there have been uses of dried olives (in whole or in part) in pasta sauces. But, again, use of dried, ground olive pulp as a base ingredient in a dry flavoring blend is not known. It has been assumed in the art that removal of most of the oil and water from the olive pulp would leave residual pulp without value. Thus, olive pulp with oil extracted has conventionally been discarded as a waste by-product.

Many spices are known in the culinary arts. Examples are salt, pepper, paprika, and cinnamon. Also, many dry flavoring blends, e.g., two or more admixed ingredients, are known in the culinary arts. Common examples include lemon pepper and garlic salt, as well as other commercially available blends, such as those produced by the Alberto-Culver Company under the “Mrs. Dash” designation. Various spices and blends have been used since antiquity to flavor foods.

However, despite the long and important history of olives, there is no known use of the pulp in dried form as an ingredient in a dry or semi-dry flavoring blend.

The health benefits of olives and olive oil have relatively recently been studied and reported. The literature suggests olive oil has favorable healthy effect on humans, particularly regarding cholesterol levels and antioxidant content.

### BRIEF SUMMARY OF THE INVENTION

The present invention includes ground dried olives and/or olive pulp as part of a dry or semi-dry flavoring blend. The blend of the present invention may be used in a variety of ways, including, but not limited to, as a seasoning or rub in food preparation process, a stir-in for liquid base food preparations such as soups and stews, or as a condiment. It may also be used as a flavoring in a marinade. It may be used with a variety of foods, such as beef, chicken, or other meats, as well as potatoes or other vegetables.

It is a principal object, feature, advantage, or aspect of the present invention to provide a dry or semi-dry flavoring blend which overcomes or solves problems, deficiencies, or needs in the art.

Other objects, features, advantages, or aspects of the present invention include a dry or semi-dry flavoring blend which:
a. uses dried and/or dehydrated olives or olive pulp as the main ingredient;
b. uses ground dried and/or dehydrated olives or olive pulp as a base ingredient with at least one other ingredient;
c. provides a unique flavor;
d. uses a base ingredient that can be combined with a variety of other ingredients;
e. may have health benefits to humans;
f. may use what was otherwise considered to be a waste by-product;
g. may be able to be produced in such a way as to be kosher;
h. is compatible with other ingredients, foods, or cooking and food preparation methods;
i. is stable in a variety of environments and conditions;
j. resists off-odors or off-flavors; and/or
k. is storable for extended periods.

Other objects, features, advantages, and aspects of the invention will become more apparent with the accompanying description.

### DETAILED DESCRIPTION OF EXEMPLARY EMBODIMENTS

A. Overview

For a better understanding of the invention, several forms it can take will now be described in detail. It is to be understood, however, that these forms are by example only, and not by way of limitation.

Dried and/or dehydrated olives are the main (meaning greatest percentage by mass or weight) ingredient in each of the exemplary embodiments described. Each of the ingredients described in the exemplary embodiments is available from a variety of commercial sources. In instances where the dried or ground version of an ingredient is not readily commercially available, manufacturers and/or individuals can dry or grind it in various ways. One example is that, for relatively small quantities, an ingredient can be dried either whole or in pieces in a standard food dehydrator, then ground in a conventional home-type food grinder. These steps can also be practiced on more massive scales utilizing larger machines.

The olives used in the present invention may be derived from a variety of sources, such as cured olives (whole or sliced, brine- or dry-cured) or olive pulp. Any variety of olive may be used according to the invention, although the exemplary embodiments describe use green olives. This usage (or any other usage described in the exemplary embodiments) is by way of example only, and is not a limitation of the scope of the invention, which is determined solely by the appended claims.

The phrases “main ingredient,” “base ingredient,” and “base flavor” are meant to describe the ingredient in the blend that comprises the highest percentage by mass or weight of the included components. All usages of percent composition in the exemplary embodiments described below are in terms of percent by mass. In each exemplary embodiment, each ingredient is preferably within 2-3% of the percentages provided or within a few grams of the indicated amounts.

The phrase “dry” is meant to describe being free or relatively free from a liquid and especially water. The term “semi-dry” is meant to describe being moderately dry.

The term “ground” is meant to describe any division of olive or olive pulp from its natural, intact size to relatively smaller units or particles, including powder or close to powder form.

Also, the term “olive pulp” is mean to include ground olives that have been dried and then reground.

B. First Exemplary Embodiment

A first exemplary embodiment comprises the following admixed blend:
about 41% ground dehydrated green olives with pimento,
about 20% ground sesame seed,
about 18% ground fennel seed,
about 10% whole sesame seed,
about 7% ground coriander, and
about 4% coarsely ground thyme.
   In commercial use, this embodiment comprises:
about 56 grams ground dehydrated green olives with pimento,
about 28 grams ground sesame seed,
about 24 grams ground fennel seed,
about 14 grams whole sesame seed,
about 10 grams ground coriander, and
about 5 grams coarsely ground thyme.
   These amounts are sufficient for two 3-ounce containers. Preferably the ingredients are mixed as evenly as possible throughout the blend.

C. Second Exemplary Embodiment

A second exemplary embodiment comprises the following blend:
about 56% finely ground dehydrated green olives,
about 20% ground sesame seed,
about 18% ground fennel seed,
about 5% ground thyme, and
about 1% ground white pepper.
   In commercial use, this embodiment comprises:
about 50 grams ground dehydrated green olives,
about 18 grams ground sesame seed,
about 16 grams ground fennel seed,
about 4 grams ground thyme, and
about 1 gram white pepper.
   These amounts are sufficient for two 2-ounce containers.

D. Third Exemplary Embodiment

A third exemplary embodiment comprises the following blend:
about 33% finely ground dehydrated green olives,
about 26% ground sesame seed,
about 15% ground fennel seed,
about 15% fennel pollen, and
about 11% whole sesame seed.
   In commercial use, this embodiment comprises:
about 35 grams finely ground dehydrated green olives,
about 28 grams ground sesame seed,
about 16 grams ground fennel seed,
about 16 grams fennel pollen, and
about 12 whole sesame seed.
   These amounts are sufficient for two 2-ounce containers.

E. Fourth Exemplary Embodiment

A fourth exemplary embodiment comprises the following blend:
about 60% finely ground dehydrated green olives,
about 23% ground sesame seed,
about 11% ground dried preserved lemon or ground dried lemon, and
about 6% ground thyme.
   In commercial use, this embodiment comprises:
about 42 grams finely ground dehydrated green olives,
about 16 grams ground sesame seed,
about 8 grams ground dried preserved lemon or ground dried lemon, and
about 4 grams ground thyme.
   These amounts are sufficient for one 3-ounce container.

F. Use

The blends can be made according to a number of methods known or within the skill of those skilled in the art. The olive meat can be dried or dehydrated using known methods. Smaller lots can even be made with commercially available conventional home use or commercial-size food dehydrators. Larger lots can be efficiently made with larger scale commercially available equipment or methods. The dried olive meat can be ground using known methods and equipment. Similarly, smaller lots can even be made with conventional home or commercial grade food grinders.

The blend can be used right after it is produced or can be packaged, preferably in a resealable but airtight container (e.g. jar with sealable cap, air impermeable plastic bag with resealable closure, etc.). The blend is relatively stable in such storage, and thus can advantageously be stored for relatively long periods of time without substantial degradation of either the ingredients or the flavor. It resists development of off odors and off flavors.

The blend can be used in a variety of ways. Previously described examples include, but are not limited to, as a rub on food that is then cooked, as a seasoning, as a condiment, or as a stir-in ingredient. But, of course, other uses are possible. For example, it can be used as a base flavorant. It could be used as a spice base in recipes, e.g., in dressings and mustards.

Amount of the blend used is discretionary. For example, if used as a seasoning, it can be sprinkled on food in a conventional manner according to taste.

These mixtures, by using dried olive in the outlined forms, further serve to impart an intense olive and/or “meaty” umami flavor in vegetarian form without the bulk or over moisturizing effect of adding nondried olive. These mixtures impart a moister texture when used on meats due to a comparatively high lipid amount. Olives and olive oil are known to have numerous health benefits via their omega-3 fatty acid content and their phytochemical profile. These natural, healthful compounds have been implicated through extensive research as possibly helping to prevent diseases such as cardiovascular disease and certain cancers.

G. Options and Alternatives

The foregoing exemplary embodiments are given by way of example only and not by way of limitation. Variations obvious to those skilled in the art are included within the invention.

For example, the precise ratio of ingredients can vary some. In the examples based on grams, it is preferable they be within a few grams of what is indicated. In the examples based on percentage, it is preferable they be within 2-3 percent or so. However, different ratios are possible.

Also different combinations are possible. The other ingredients listed are but a few examples.

While the previously described embodiments are exemplary, other blends with dried or dehydrated olives or olive pulp as the main ingredient are contemplated under the present invention. As the presence of olives in the blend tends to give a “Mediterranean” flavor, other spices and flavorings, either indigenous or commonly used in areas around the Mediterranean, such as ajwain, anise, bay leaves, capers, caperberries, chili peppers, cinnamon, coriander (leaf or seed), cumin, dill weed, fennel, hyssop, garden cress, juniper, lavender, mahaleb cherry, myrtle, nigella, nutmeg, oregano, paprika, parsley, pepper, red pepper, rocket, rosemary, rue, sage, saffron, salt, savory, sumac, thyme, and others are also within the scope of the invention.

A particularly unique combination comprises the ground dried olive base ingredient with fennel pollen. In the U.S., fennel is a relatively rare plant, and fennel pollen is uncommon and rare as a flavoring. However, it is commercially available.

Regarding the olives themselves, if they can be purchased from a custom supplier in dried or dehydrated form, they usually can be used directly in the blend. Otherwise, regular whole or diced olives in non-dried form can be purchased and dried whole or in pieces. One way is freeze drying (olives cannot naturally be air dried). Another technique would be in a conventional off-the-shelf food dehydrator. Other ingredients can be bought in dry form or dried in similar ways.

Olives or other ingredients, once dry, can be ground by any of a number of ways, including using conventional off-the-shelve food grinders. The size and uniformity of the ground particles can be selected. They can be substantially uniform or can vary. Preferably they would be substantially uniform and of an average size similar to particles in other commercially available flavoring blends. One example of a relatively coarse granulation of the blend particles would be 95% through a US#20 sieve. There could be different particle size distributions, including on the order of finely ground dry spices or flavorings.

The invention pertains to a flavoring blend having ground and dried olives or olive pulp. It does not require the olive or olive pulp to be ground or dried in any particular order. However, it is preferred that it be dried first and then ground.

Other processing steps can be included in making of the blend. For example, the blend, or any ingredient of it, can be washed and/or sterilized. Other conventional food processing or handling steps can be used.

One source of dried olive pulp is from olive oil production facilities. In one example of olive oil extraction, the majority of oil is squeezed from the olive pulp. To try to get as much of the oil that might remain after squeezing, the squeezed olive pulp is soaked in water for a period of time. This releases additional oil, which floats to the top of the water and is skimmed off. It has been found that even though most of the oil is removed, there is still some remaining in the pulp. Also, antioxidants have been found in the soaking water. Some of that water is retained in the pulp even after the pulp is removed and dried. Thus, even the dried pulp contains health-promoting antioxidants. The antioxidants are thus present when the dried pulp is used in the flavoring blends according to the present invention.

What is claimed is:

1. A dry or semi-dry flavoring blend comprising:
a majority, by mass, of ground dried and/or dehydrated olives or olive pulp; and
one or more other ingredient flavoring, seasoning, condiment, herb, extract, or spice.

2. The flavoring blend of claim 1 wherein the olives comprise one or more of:
Amphissa, Arbequina, Black, Cerignola, Cipollini, Gaeta, Green, Kalamata, Moroccan, Nicoise, Picholine, Sicilian, or Spanish olives.

3. The flavoring blend of claim 1 further comprising pimento of the olive.

4. The flavoring blend of claim 1 wherein the ground dried and/or dehydrated olives or olive pulp is/are from green olives.

5. The flavoring blend of claim 1 wherein the one or more other ingredient comprises one or more of a flavoring, seasoning, condiment, herb, extract, or spice.

6. The flavoring blend of claim 1 wherein the one or more other ingredient comprises fennel pollen.

7. The flavoring blend of claim 1, wherein the one or more other ingredient comprises one or more of:
ajwain, anise, bay leaves, capers, caperberries, chili peppers, cinnamon, coriander (leaf or seeds), cumin, dill weed, dried lemon, fennel, fennel pollen, fennel seed, hyssop, garden cress, lavender, mahaleb cherry, myrtle, nigella, nutmeg, oregano, paprika, parsley, pepper, red pepper, rocket, rosemary, rue, sage, saffron, salt, savory, sesame seed, sumac, and thyme.

8. The flavoring blend of claim 1, wherein the blend comprises:
about 41% ground dehydrated green olives with pimento,
about 20% ground sesame seed,
about 18% ground fennel seed,
about 10% whole sesame seed,
about 7% ground coriander, and
about 4% coarsely ground thyme.

9. The flavoring blend of claim 1, wherein the blend comprises:
about 56% finely ground dehydrated green olives,
about 20% ground sesame seed,
about 18% ground fennel seed,
about 5% ground thyme, and
about 1% ground pepper.

10. The flavoring blend of claim 1, wherein the blend comprises:
about 33% finely ground dehydrated green olives,
about 26% ground sesame seed,
about 15% ground fennel seed,
about 15% fennel pollen, and
about 11% whole sesame seed.

11. The flavoring blend of claim 1, wherein the blend comprises:
about 60% finely ground dehydrated green olives,
about 23% ground sesame seed,
about 11% ground dried preserved lemon or ground dried lemon, and
about 6% ground thyme.

12. A rub or seasoning for use in preparing or consuming food comprising:
a. a base ingredient comprising ground dried or dehydrated olive; and
b. a second ingredient.

13. The rub or seasoning of claim 12 wherein the ground dried or dehydrated olive is made from the pulp of one or more olives.

14. The rub or seasoning of claim 12 wherein the ground dried or dehydrated olive does not include olive wood or pit.

15. The rub or seasoning of claim 12 wherein the base ingredient comprises another spice.

16. The rub or seasoning of claim 12 wherein the second ingredient is a spice.

17. The rub or seasoning of claim 12 wherein the second ingredient is fennel pollen.

18. The rub or seasoning of claim 12 wherein the second ingredient is fennel which is ground.

19. The rub or seasoning of claim 12 wherein the second ingredient is fennel which is whole.

20. The rub or seasoning of claim 17 further comprising a third ingredient.

21. The rub or seasoning of claim 20 wherein the third ingredient comprises coriander, thyme, pepper, or lemon.

22. The rub or seasoning of claim 12 wherein the base ingredient and the second ingredient are blended.

23. The rub or seasoning of claim 12 wherein the rub or seasoning is kosher.

24. The rub or seasoning of claim 12 wherein the base ingredient and second ingredient are in dry form.

25. The rub or seasoning of claim 12 stored in a sealable container.

26. A method of making a rub or seasoning for use in preparing or consuming food comprising:
a. providing ground dried or dehydrated olive; and
b. blending the ground dried or dehydrated olive with a second ingredient.

27. The method of claim 26 wherein the ground dried or dehydrated olive is made from the pulp of one or more olives.

28. The method of claim 26 wherein the ground dried or dehydrated olive does not include olive wood or pit.

29. The method of claim 26 wherein the ground dried or dehydrated olive is made by drying whole olives.

30. The method of claim 26 wherein the ground dried or dehydrated olive is made by drying parts of olives.

31. The method of claim 26 wherein the ground dried or dehydrated olive is made by drying in a food dehydrator.

32. The method of claim 26 wherein the ground dried or dehydrated olive is made by grinding in a food grinder.

33. The method of claim 26 wherein the base ingredient comprises another spice.

34. The method of claim 26 wherein the second ingredient is a spice.

35. The method of claim 26 wherein the second ingredient comprises fennel pollen.

36. The method of claim 26 wherein the base ingredient and the second ingredient are blended in dry form.

37. The method of claim 26 wherein the rub or seasoning is kosher.

38. The method of claim 26 wherein the base ingredient and second ingredient are in dry form.

39. The method of claim 27 further comprising storing the blend in a sealable container.

40. A composition for addition to food comprising:
a. a dry or semi-dry food flavoring blend;
b. the blend comprising olive or olive pulp which is ground and dried.

41. The composition of claim 40 further comprising a second ingredient.

42. The composition of claim 41 wherein the second ingredient is fennel pollen.
